(19) United States
(12) Patent Application Publication
(10) Pub. No.: US 2020/0070381 A1
(43) Pub. Date: Mar. 5, 2020

(54) Device for removing the knots of moso bamboo

(71) Applicant: Ying Xu, Fuzhou City (CN)

(72) Inventor: Ying Xu, Fuzhou City (CN)

(21) Appl. No.: 16/679,293

(22) Filed: Nov. 11, 2019

(30) Foreign Application Priority Data
Sep. 6, 2019 (CN) 2019108409461

(51) Int. Cl. B27G 1/00; B27J 1/00

(52) U.S. Cl. CPC B27G 1/00; B27J 1/00

(57) ABSTRACT

The invention discloses a slub removing device for bamboo processing, which includes a machine body. The machine body is provided with a working cavity, the top wall of the working cavity is provided with a connecting space, the top wall of the connecting space is provided with a grinding cavity. First, the bamboo is inserted between the pressing plate and the butt joint plate. Compared with manual grinding, the device does not need workers to scrape the branches and scrape the bamboo with a sickle. The device only needs to insert the bamboo into the device, and then automatically polish and remove the branches and scraped branches and bamboo chips through the mechanical structure. At the same time, the device can automatically scrape the branches and bamboo chips Discharge the device without manual operation.

### CROSS-REFERENCES TO RELATED APPLICATIONS

The present application claims priority from Chinese application No. 2019105910561 filed on Jul. 2, 2019 which is hereby incorporated by reference in its entirety.

### TECHNICAL FIELD

The present invention relates to the field of bamboo processing, in particular to a device for removing the knots of moso bamboo.

### BACKGROUND OF THE INVENTION

With the improvement of people's technology level, many people like to use bamboo as raw materials to produce and process some daily necessities, such as building materials, brooms, tables, chairs, etc. at the same time, bamboo can also be used to make baskets, back baskets, vegetable baskets, Mats and other articles. Therefore, as a plant with strong regeneration ability, bamboo is very environmentally friendly to process things.

After the bamboo is cut down, some bamboo knots and redundant branches need to be removed. However, the general removal method is manual, which is not only time-consuming and laborious, but also easy to cause damage to the bamboo, so that the cut bamboo can not be used.

### BRIEF SUMMARY OF THE INVENTION

The object of the invention is to provide a slub removing device for bamboo processing, so as to solve the problems raised in the background technology.

To achieve the above purpose, the invention provides the following technical scheme: a bamboo knuckle removal device for bamboo processing, including a body, wherein the body is provided with a working cavity, the top wall of the working cavity is provided with a connection space, the top wall of the connection space is provided with a grinding cavity, and the grinding cavity is provided with a removal device for removing branches and grinding bamboo knuckles for bamboo;

The cleaning device includes rotating the motor shaft installed on the front and rear side walls of the grinding chamber, the front side of the motor shaft is fixedly provided with a first bevel gear, the bottom wall of the grinding chamber and the top wall of the working chamber are rotationally connected with the grinding shaft, the top side of the grinding shaft is fixedly provided with a second bevel gear meshed with the first bevel gear, the middle side of the grinding shaft is fixedly provided with a cam, and The bottom side of the grinding shaft is fixedly provided with a grinding block for grinding, the bottom wall of the grinding chamber is slidably connected with a pushing plate, the pushing plate is butted with the cam, the pushing plate is connected with the grinding chamber with a strong spring, the right side of the pushing plate is fixedly provided with a scraping block which is slidably connected with the connecting space, and the top wall of the working chamber is symmetrically provided with a transmission cavity on the left and right;

The conveying cavity is provided with a conveying device for transporting bamboo, the bottom wall of the working cavity is provided with an opening and a torsion cavity, between the opening and the torsion cavity is provided with a supporting device for supporting bamboo according to the size of the bamboo diameter, the bottom wall of the opening is provided with a rope groove, one side of the rope groove is connected with a working cavity, and the left wall of the working cavity is provided with a spring cavity The spring cavity is provided with an auxiliary device for supporting bamboo, the bottom wall of the working cavity is also provided with a conveying cavity with an opening to the rear, the conveying cavity is provided with a discharge device for discharging bamboo chips and branches, the bottom wall of the conveying cavity is also provided with a drain port against the opening to the bottom, the top side of the conveying cavity is provided with a power cavity, and the power cavity is provided with a driving and clearing device for grinding The top side of the power chamber is provided with a water tank, and the water tank is provided with a dust reducing water spray device.

On the basis of the above technical scheme, the conveying device comprises a support rod and a fixed rod symmetrically installed on the top wall of the conveying cavity, each of which is rotationally connected with a transverse axis, on which are respectively fixed longitudinal rollers, one side of which is fixed with a third bevel gear, and each of which is rotationally connected with the rear wall of the working cavity The front side of the through shaft is fixedly provided with a fourth bevel gear meshed with the third bevel gear, and the rear side of the through shaft is fixedly provided with a transverse roller.

On the basis of the above technical scheme, the supporting device includes rotating a torsion shaft installed on the front and rear side walls of the torsion cavity, the torsion shaft and the torsion cavity are connected with a torsion spring, the torsion shaft is fixedly provided with a pressing plate, the left side of the pressing plate is hinged with an articulated rod, the left side of the articulated rod is hinged with a transverse rack which is slidably connected with the bottom wall of the working cavity, and the opening The front and rear side walls of the cavity are rotationally connected with a coupling shaft, the rear side of the coupling shaft is fixedly provided with a driven gear meshed with the transverse rack, the front side of the coupling shaft is fixedly provided with a winding wheel, and the top wall of the working cavity is fixedly provided with a butting plate matched with a pressing plate.

On the basis of the above technical scheme, the auxiliary device comprises an auxiliary rod slidably installed in the rope groove, the left side of the auxiliary rod is fixedly provided with a spring block slidably connected with the spring chamber, and the auxiliary rod and the winding wheel are connected with a long rope.

On the basis of the above technical scheme, the discharge device includes a conveying motor fixed on the left side wall of the conveying cavity, wherein the power of the conveying motor is connected with a drive shaft which is rotationally connected with the right side wall of the conveying cavity, the left and right side walls of the conveying cavity are rotationally connected with an discharge shaft, the discharge shaft and the drive shaft are symmetrically fixed with a conveying roller, of which There is a conveyor belt connected between.

On the basis of the above technical scheme, the power device comprises a power motor fixed on the rear side wall of the power cavity, the through shaft and the motor axial extend backward into the power cavity, and are rotationally connected with the front side wall of the power cavity, the conveyor belt and the motor shaft are dynamically connected, and the motor shaft and the right through shaft are symmetrically fixed with a large The large belt pulley is connected with the large belt, the two through shafts are symmetrically fixed with the small belt pulley, and the two small belt pulleys are connected with the small belt.

On the basis of the technical scheme, the water spray device comprises a drainage pump arranged on the bottom wall of the water tank.

On the basis of the technical scheme, the horizontal roller and the longitudinal roller are made of rubber materials.

On the basis of the above technical scheme, the bottom surface of the body is symmetrically and fixedly provided with a base for supporting the body.

To sum up, the beneficial effect of the invention is: compared with manual grinding, the device can remove and polish the newly cut bamboo. The device does not require workers to scrape the bamboo branches with sickles. The device only needs to insert the bamboo into the device, and then automatically polish and remove the branches through mechanical structure;

At the same time, the device can automatically discharge the scraped branches and bamboo scraps from the device, without the need for the operator to discharge them manually. At the same time, the device can spray water on the bamboo in advance, which can effectively prevent the bamboo scraps flying when cutting and grinding.

### BRIEF DESCRIPTION OF THE DRAWINGS

In order to explain the embodiments of the invention or the technical solutions in the prior art more clearly, the following will give a brief introduction to the drawings needed in the embodiments or the prior art description. Obviously, the figures in the following description are only some embodiments of the invention. For those skilled in the art, other figures can be obtained according to these figures without any creative work.

FIG. 1 is the overall schematic structural diagram of the device for removing the knots of moso bamboo;

FIG. 2 is the sectional main view of the back side in FIG. 1 of the invention;

FIG. 3 is a side view of the pressing plate in FIG. 1 of the present invention;

FIG. 4 is a side view of the butt joint plate in FIG. 1 of the present invention;

FIG. 5 is a side view of the auxiliary rod in FIG. 1 of the invention.

### DETAILED DESCRIPTION OF THE INVENTION

All the features disclosed in the specification, or the steps in all the methods or processes disclosed, can be combined in any way except the mutually exclusive features and/or steps.

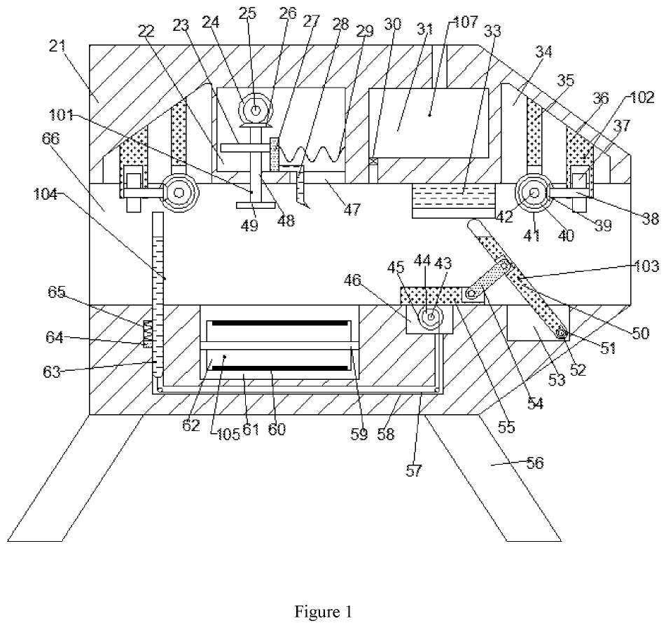

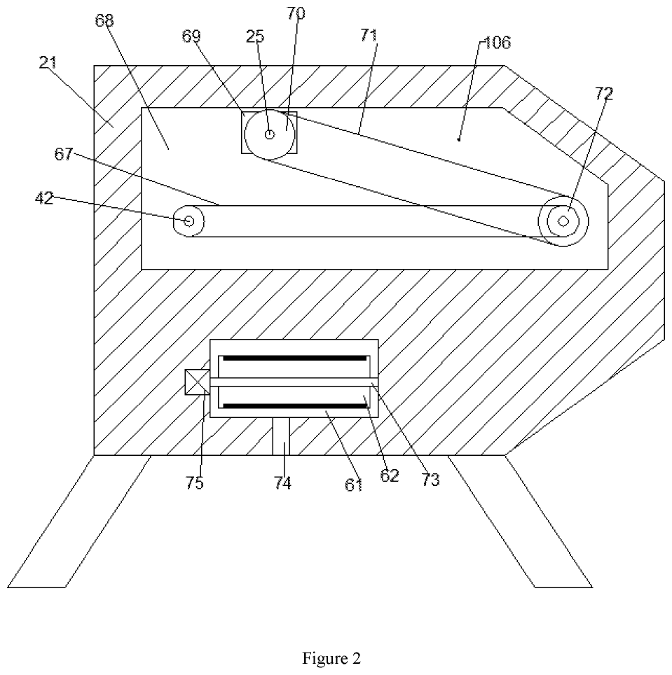

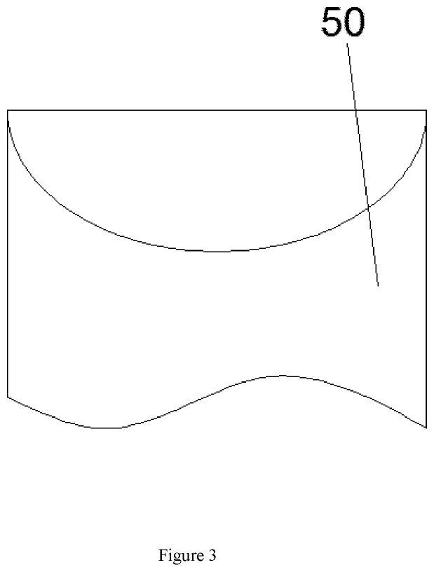

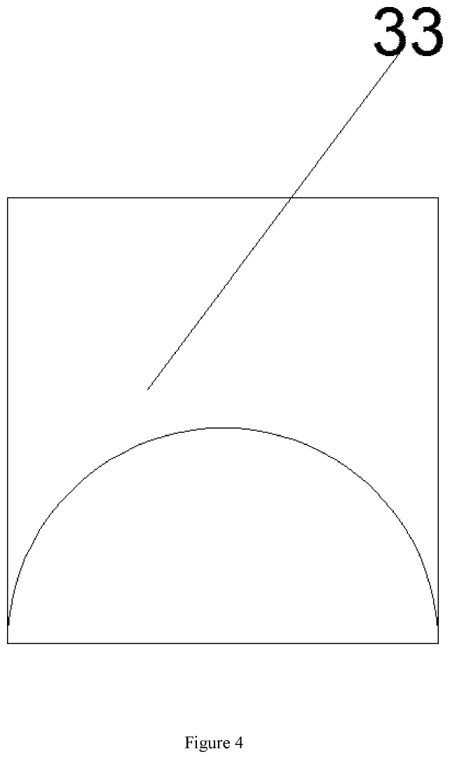

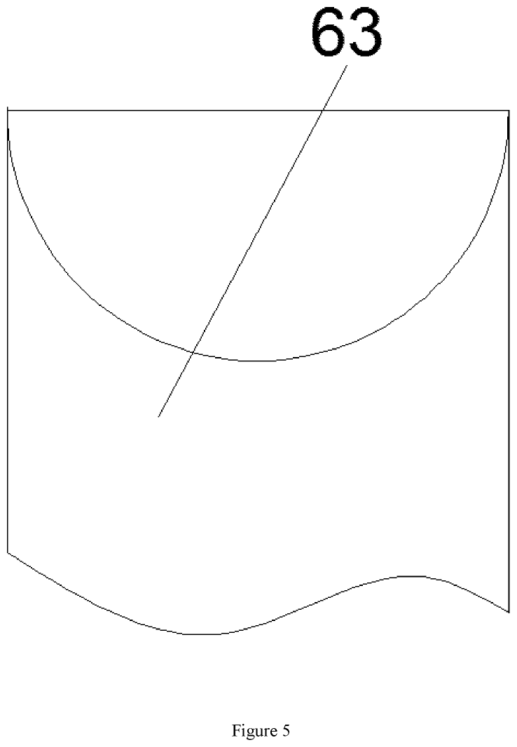

Referring to FIG. 1-5, the invention provides an embodiment: a bamboo knuckle removal device for bamboo processing, including a body 21, wherein the body 21 is provided with a working cavity 66, the top wall of the working cavity 66 is provided with a connection space 47, the top wall of the connection space 47 is provided with a grinding cavity 22, and the grinding cavity 22 is provided with a removal device 101 for removing branches for bamboo and grinding bamboo knuckles The cleaning device 101 includes a motor shaft 25 installed on the front and rear side walls of the grinding chamber 22, the front side of the motor shaft 25 is fixedly provided with a first bevel gear 24, the bottom wall of the grinding chamber 22 and the top wall of the working chamber 66 are rotationally connected with the grinding shaft 48, the top side of the grinding shaft 48 is fixedly provided with a second bevel gear 26 which is meshed with the first bevel gear 24, and the middle side of the grinding shaft 48 is fixedly provided There is a cam 23, the bottom side of the grinding shaft 48 is fixedly provided with a grinding block 49 for grinding, the bottom wall of the grinding chamber 22 is slidably connected with a push plate 27, the push plate 27 is butted with the cam 23, the push plate 27 and the grinding chamber 22 are connected with a strong spring 29, the right side of the push plate 27 is fixedly provided with a scraping block 28 slidably connected with the connecting space 47, and the work The top wall of the cavity 66 is symmetrically provided with a conveying cavity 34, in which a conveying device 102 for transporting bamboo is arranged, the bottom wall of the working cavity 66 is provided with an opening 46 and a torsion cavity 53, between the opening 46 and the torsion cavity 53 is provided with a supporting device 103 for supporting bamboo according to the size of the bamboo diameter, the bottom wall of the opening 46 is provided with a rope groove 58, and the bottom wall of the rope groove 58 is provided with a rope groove 58 One side is connected with a working cavity 66, the left wall of the working cavity 66 is provided with a spring cavity 65, the spring cavity 65 is provided with an auxiliary device 104 for supporting bamboo, the bottom wall of the working cavity 66 is also provided with a conveying cavity 61 with an opening backward, the conveying cavity 61 is provided with a discharge device 105 for discharging bamboo chips and branches, the bottom wall of the conveying cavity 61 is also provided with a drain 74 against the opening downward, and The top side of the conveying cavity 61 is provided with a power cavity 68 which is provided with a power device 106 for grinding by a driving and clearing device 101. The top side of the power cavity 68 is provided with a water tank 31, which is provided with a dust reducing water spray device 107.

In addition, in one embodiment, the conveying device 102 includes a supporting rod 35 and a fixing rod 36 symmetrically arranged on the top wall of the conveying cavity 34, each of which is rotationally connected with a horizontal shaft 38, on which a longitudinal roller 37 is fixedly fixed, one side of which is fixedly provided with a third bevel gear 39, and each of which is rotationally connected with the worker The front side of the through shaft 42 is fixedly provided with a fourth bevel gear 40 meshed with the third bevel gear 39, and the rear side of the through shaft 42 is fixedly provided with a transverse roller 41, so as to drive the fourth bevel gear 40, the transverse roller 41, the third bevel gear 39, the transverse shaft 38 and the longitudinal roller 3 when the through shaft 42 rotates 7 rotate, the horizontal roller 41 drives the bamboo to move to the left, and the vertical roller 37 drives the bamboo to rotate.

In addition, in one embodiment, the support device 103 includes a torsion shaft 52 rotating and installed on the front and rear side walls of the torsion cavity 53, the torsion shaft 52 and the torsion cavity 53 are connected with a torsion spring 51, the torsion shaft 52 is fixedly provided with a pressing plate 50, the left side of the pressing plate 50 is hinged with an articulated rod 54, the left side of the articulated rod 54 is hinged with a transverse sliding connection with the bottom wall of the working cavity 66 The front and rear side walls of the opening 46 are rotationally connected with the connecting shaft 43, the rear side of the connecting shaft 43 is fixedly provided with the driven gear 45 which is meshed with the transverse rack 55, the front side of the connecting shaft 43 is fixedly provided with the winding wheel 44, the top wall of the working chamber 66 is fixedly provided with the butt joint plate 33 which is matched with the press plate 50, and the bamboo is inserted between the press plate 50 and the butt joint plate 33, so as to The articulated rod 54 drives the traverse rack 55 to move to the left, so that the driven gear 45, the coupling shaft 43 and the winding wheel 44 rotate.

In addition, in one embodiment, the auxiliary device 104 includes an auxiliary rod 63 slidably installed in the rope groove 58, the left side of the auxiliary rod 63 is fixedly provided with a spring block 64 slidably connected with the spring cavity 65, and the long rope 57 is connected between the auxiliary rod 63 and the winding wheel 44, when the winding wheel 44 rotates, the long rope 57 is relaxed, and is reset through the spring cavity 65, so that And the auxiliary rod 63 moves upward.

In addition, in one embodiment, the discharge device 105 includes a delivery motor 75 fixed on the left wall of the delivery cavity 61, wherein the power of the delivery motor 75 is connected with a drive shaft 73 rotationally connected with the right wall of the delivery cavity 61, the left and right walls of the delivery cavity 61 are rotationally connected with the discharge shaft 59, and the delivery roller 62 is symmetrically fixed on the discharge shaft 59 and the drive shaft 73 The conveying roller 62 is connected with the conveying belt 60, so as to open the conveying motor 75, drive the drive shaft 73, the conveying roller 62 and the discharge shaft 59 to rotate, so as to discharge the fallen bamboo branches and bamboo chips from the conveying cavity 61.

In addition, in one embodiment, the power device 106 includes a power motor 69 fixed on the rear wall of the power cavity 68, the through shaft 42 and the motor shaft 25 extend backward into the power cavity 68, and are rotationally connected with the front wall of the power cavity 68, the conveyor belt 60 is powerfully connected with the motor shaft 25, and the motor shaft 25 and the through shaft 4 on the right side 2. A large belt pulley 70 is symmetrically fixed on the upper part, a large belt 71 is connected between the large belt pulley 70, a small belt pulley 72 is symmetrically fixed on the two through shafts 42, and a small belt 67 is connected between the two small belt pulleys 72, so as to open the power motor 69, thereby driving the electric shaft 25, the large belt pulley 70, the small belt pulley 72 and the through shaft 42 to rotate.

In addition, in one embodiment, the water spray device 107 includes a drainage pump 30 arranged on the bottom wall of the water tank 31, so as to add water to the drainage pump 30, and then open the drainage pump 30, so as to spray the water in the water tank 31 onto the bamboo.

In addition, in one embodiment, the transverse roller 41 and the longitudinal roller 37 are made of rubber material, which can effectively drive the bamboo to rotate and move to the left.

In addition, in one embodiment, the bottom surface of the body 21 is symmetrically provided with a base 56 for supporting the body 21.

When it is necessary to remove the bamboo nodes and branches, first insert the bamboo between the pressing plate 50 and the butt joint plate 33, so as to drive the traverse rack 55 to move to the left through the articulated rod 54, so as to make the driven gear 45, the coupling shaft 43 and the winding wheel 44 rotate. When the winding wheel 44 rotates, the waiting rope 57 is relaxed, and the auxiliary rod 63 moves upward through the auxiliary rod through the spring chamber 65 63 and the pressing plate 50 clamp the bamboo, then add water to the water tank 31, then turn on the drainage pump 30, so as to spray the water in the water tank 31 on the bamboo, so as to prevent the bamboo chips from flying when the bamboo is being polished;

Then turn on the power motor 69 to drive the rotation of the motor shaft 25, the large pulley 70, the small pulley 72 and the through shaft 42. When the through shaft 42 rotates, the fourth bevel gear 40, the transverse roller 41, the third bevel gear 39, the transverse shaft 38 and the longitudinal roller 37 will be driven. The transverse roller 41 will drive the bamboo to move to the left, the longitudinal roller 37 will drive the bamboo to rotate, and the motor shaft 25 will drive the first bevel gear The wheel 24, the second bevel gear 26, the grinding shaft 48, the cam 23 and the grinding block 49 rotate so as to polish the slugs. The hole of the cam 23 pushes the plate 27 and the scraping block 28 to move about, so as to scrape the branches on the bamboo;

Then, the conveying motor 75 is opened to drive the drive shaft 73, the conveying roller 62 and the discharge shaft 59 to rotate, so as to discharge the fallen bamboo branches and bamboo chips from the conveying cavity 61, thus completing the processing of bamboo.

The beneficial effect of the invention is that the device can remove branches and polish the newly cut bamboo, compared with manual polishing, the device does not require workers to scrape branches of bamboo with sickles, the device only needs to insert bamboo into the device, and then automatically polish and remove branches through mechanical structure;

At the same time, the device can automatically discharge the scraped branches and bamboo scraps from the device, without the need for the operator to discharge them manually. At the same time, the device can spray water on the bamboo in advance, which can effectively prevent the bamboo scraps flying when cutting and grinding.

The above is only the specific embodiment of the invention, but the scope of protection of the invention is not limited to this. Any change or replacement without thinking of creative labor shall be covered in the scope of protection of the invention. Therefore, the scope of protection of the invention shall be subject to the scope of protection defined in the claims.

1. A device for removing the knots of moso bamboo, comprising a machine body; the machine body is provided with a working cavity, the top wall of the working cavity is provided with a connecting space, the top wall of the connecting space is provided with a grinding cavity, and the grinding cavity is provided with a clearing device for removing branches and grinding bamboo nodes for bamboo;
The cleaning device includes rotating the motor shaft installed on the front and rear side walls of the grinding chamber, the front side of the motor shaft is fixedly provided with a first bevel gear, the bottom wall of the grinding chamber and the top wall of the working chamber are rotationally connected with the grinding shaft, the top side of the grinding shaft is fixedly provided with a second bevel gear meshed with the first bevel gear, the middle side of the grinding shaft is fixedly provided with a cam, and The bottom side of the grinding shaft is fixedly provided with a grinding block for grinding, the bottom wall of the grinding chamber is slidably connected with a pushing plate, the pushing plate is butted with the cam, the pushing plate is connected with the grinding chamber with a strong spring, the right side of the pushing plate is fixedly provided with a scraping block which is slidably connected with the connecting space, and the top wall of the working chamber is symmetrically provided with a transmission cavity on the left and right;
The conveying cavity is provided with a conveying device for transporting bamboo, the bottom wall of the working cavity is provided with an opening and a torsion cavity, between the opening and the torsion cavity is provided with a supporting device for supporting bamboo according to the size of the bamboo diameter, the bottom wall of the opening is provided with a rope groove, one side of the rope groove is connected with a working cavity, and the left wall of the working cavity is provided with a spring cavity The spring cavity is provided with an auxiliary device for supporting bamboo, the bottom wall of the working cavity is also provided with a conveying cavity with an opening to the rear, the conveying cavity is provided with a discharge device for discharging bamboo chips and branches, the bottom wall of the conveying cavity is also provided with a drain port against the opening to the bottom, the top side of the conveying cavity is provided with a power cavity, and the power cavity is provided with a driving and clearing device for grinding The top side of the power chamber is provided with a water tank, and the water tank is provided with a dust reducing water spray device.

2. The device for removing the knots of moso bamboo as defined in claim 1, wherein The conveying device comprises a supporting rod and a fixing rod symmetrically installed on the top wall of the conveying cavity, each fixing rod is rotationally connected with a transverse shaft, the transverse shaft is respectively fixed with a longitudinal roller, one side of the transverse shaft is fixed with a third bevel gear, each supporting rod is rotationally connected with a through shaft rotationally connected with the rear wall of the working cavity, and the through shaft The front side is fixedly provided with a fourth bevel gear which is meshed with the third bevel gear, and the rear side through the shaft is fixedly provided with a transverse roller.

3. The device for removing the knots of moso bamboo as defined in claim 2, wherein The supporting device comprises a torsion shaft which is rotationally installed on the front and rear side walls of the torsion cavity, the torsion shaft is connected with the torsion cavity by a torsion spring, the torsion shaft is fixedly provided with a pressing plate, the left side of the pressing plate is hinged with an articulated rod, the left side of the articulated rod is hinged with a transverse rack which is slidably connected with the bottom wall of the working cavity, the front and rear side walls of the opening are rotationally connected with The rear side of the coupling shaft is fixedly provided with a driven gear meshed with the traverse rack, the front side of the coupling shaft is fixedly provided with a winding wheel, and the top wall of the working chamber is fixedly provided with a butting plate matched with the pressing plate.

4. The device for removing the knots of moso bamboo as defined in claim 1, wherein The valve locking mechanism comprises a locking pin symmetrically arranged at the bottom end of the rotary hollow shaft on the left and right sides, the locking pin outer wall is elastically provided with a locking pin return spring, the locking pin return spring is fixed on the inner wall of the rotary hollow shaft on the side far away from the central control pin, the locking pin is close to the side of the central control pin, and is in contact with the central control pin.

5. The device for removing the knots of moso bamboo as defined in claim 1, wherein The discharge device includes a conveying motor fixed on the left side wall of the conveying cavity. The conveying motor is dynamically connected with a driving shaft which is rotationally connected with the right side wall of the conveying cavity. The left and right side walls of the conveying cavity are rotationally connected with a discharge shaft. The discharge shaft and the driving shaft are symmetrically fixed with a conveying roller which is connected with a conveying belt.

6. The device for removing the knots of moso bamboo as defined in claim 1, wherein The power device includes a power motor fixed on the rear side wall of the power cavity, the through shaft and the motor shaft extend backward into the power cavity, and are rotationally connected with the front side wall of the power cavity, the conveyor belt is connected with the motor shaft, the motor shaft and the through shaft on the right side are symmetrically fixed with a large belt pulley, and the large belt pulley A large belt is connected between the two through shafts, a small belt pulley is symmetrically fixed, and a small belt is connected between the two small belt pulleys.

7. The device for removing the knots of moso bamboo as defined in claim 1, wherein The water spray device includes a drainage pump arranged on the bottom wall of the water tank.

8. The device for removing the knots of moso bamboo as defined in claim 1, wherein The transverse roller and the longitudinal roller are made of rubber materials.

9. The device for removing the knots of moso bamboo as defined in claim 1, wherein The bottom surface of the body is symmetrically and fixedly provided with a base for supporting the body.
